(19) United States
(12) Patent Application Publication
(10) Pub. No.: US 2025/0258856 A1
(43) Pub. Date: Aug. 14, 2025

(54) DECLARATIVE AGENT WITH HIERARCHICAL COMPONENTS USING LARGE LANGUAGE MACHINE-LEARNED MODELS

(71) Applicant: Sierra Technologies, Inc., San Francisco, CA (US)

(72) Inventors: Bret Steven Taylor, Lafayette, CA (US); Clayton Woodward Bavor, JR., Atherton, CA (US); Arya Asemanfar, San Francisco, CA (US); Julie Christina Tung, Los Altos, CA (US); Belinda Helen Gu, San Francisco, CA (US); Karthik Rajagopal Narasimhan, Foster City, CA (US); Noah Ryan Shinn, San Francisco, CA (US); Natalie Ann Meurer, San Francisco, CA (US); Julien Zachary Reneau-Wedeen, San Francisco, CA (US); Nayely Edith Martinez, Los Angeles, CA (US); Nishita Vijay Jain, San Francisco, CA (US)

(21) Appl. No.: 19/051,047

(22) Filed: Feb. 11, 2025

Related U.S. Application Data
(60) Provisional application No. 63/552,623, filed on Feb. 12, 2024.
(60) Provisional application No. 63/643,183, filed on May 6, 2024.
(60) Provisional application No. 63/712,165, filed on Oct. 25, 2024.

(51) Int. Cl. G06F 16/35; G06F 40/35

(52) U.S. Cl. CPC G06F 16/35; G06F 40/35

(57) ABSTRACT

A declarative agent service deploys a hierarchical set of skills with a large language model (LLM) to generate a response to a user input. An agent of the declarative agent service receives a prompt from a user. The agent inputs the prompt into an LLM, which is trained using a taxonomy having a plurality of root classifications, and a set of child classifications under each root classification. The agent receives, from the LLM, a classification corresponding to one of the child classifications based on the prompt. The agent may deploy a hierarchical set of skills to iteratively identify one or more LLM calls based on the classification. Responsive to detecting an exception during deployment of the hierarchical set of skills, the agent overrides the deployment by performing an exception activity.

### CROSS-REFERENCE TO RELATED APPLICATIONS

This application claims the benefit of U.S. Provisional Application No. 63/552,623, filed Feb. 12, 2024, the benefit of U.S. Provisional Application No. 63/643,183, filed May 6, 2024, and the benefit of U.S. Provisional Application No. 63/712, 165, filed Oct. 25, 2024, the disclosures of which are hereby incorporated by reference herein in their entireties.

### TECHNICAL FIELD

The disclosure generally relates to the field of artificial intelligence, and more specifically relates to using declarative syntax to operate a declarative agent using hierarchical components.

### BACKGROUND

Agents are software that coordinate sequences of interactions with AI (artificial intelligence), such as LLMs (large language models) and external software systems. In chat automation systems, LLMs are difficult to deploy because they are not deterministic. This limitation may result in inconsistent actions being taken and inconsistent messaging given similar prompts that should yield consistent messaging. This limitation may also result in hallucinations that provide inaccurate or dangerous information or improper actions.

Existing methods of using LLMs to analyze user prompts often involve using large total sets of classification categories as long as they are organized into semantic groupings that allow for incremental refinement. The LLMs may be provided with a fully enumerated list of classification categories upfront, either as a labeled or numbered set of options. The model then selects the most appropriate category based on the given input. While this approach may seem straightforward, it becomes inefficient when dealing with large classification sets.

One major issue with this method is scalability. If the number of categories is too large, listing them all in a single prompt can overwhelm the model. LLMs have a finite context window, meaning that excessively long lists may get truncated or become too complex for the model to process effectively. Additionally, when too many options are presented at once, the model may struggle to distinguish between closely related categories, leading to inaccurate classifications. Another concern is token usage efficiency. Since LLMs process text token by token, listing all possible categories consumes a significant portion of the prompt, even if only a small fraction of the categories is relevant for a given input. This increases computational costs and slows down response times unnecessarily. A more efficient approach would be to refine classification dynamically rather than providing an exhaustive list from the outset.

### SUMMARY

Systems and methods are disclosed herein that deploys a hierarchical set of skills with a large language model (LLM) to generate a response to a user input. In some embodiments, an agent of the declarative agent service receives a user input from a user. The agent may generate a prompt to an LLM using the user input. The agent inputs the prompt into the LLM, which is trained using a taxonomy having a plurality of root classifications, and each root classification may include a set of child classifications. The agent receives, from the LLM, a classification corresponding to one of the child classifications based on the prompt. The agent may deploy a set of skills to iteratively identify one or more LLM calls based on the classification. The set of skills may be in a hierarchical structure. The agent deploys the set of skills to generate a response to the user input. In some embodiments, the declarative agent service may define a set of exceptions and corresponding exception activities. Responsive to detecting an exception during deployment of the hierarchical set of skills, the agent overrides the deployment by performing an exception activity.

This method of providing specific exceptional scenarios has proved invaluable in having predictable behavior from LLM-based agents. Hallucination occurs because instruction-tuned LLMs are very good at following instructions, so when provided instructions that closely match the situation that has arisen, they tend to follow the instructions. On the other hand, when encountering a situation for which there are no instructions the LLM tends to pay attention to the behaviors encoded in the base model which are often not the appropriate response in a real-world customer scenario. For example, if a user inputs “I want to cancel my order” but there were no instructions provided to the LLM regarding cancellations, the LLM may respond with what is a typical response in this situation such as “I've cancelled your order,” even though no action had been taken. The context-aware hierarchical exception method disclosed herein enables the agent to use exception detection to identify these invalid states such that the LLM is not prompted to respond in an invalid state. The use of specific exceptions reduces the probability that an LLM introduces hallucination.

The system and method disclosed herein have many advantages and benefits over prior systems. The disclosed system is scalable and maintainable because of the declarative nature of the specification, code written with the system leveraging skills that can be arbitrarily nested without loss of readability. This allows extensions to the behavior to be made while maintaining ideal modularity. In typical software systems, complexity (for a human to interpret and maintain) increases as hierarchy increases whereas with the disclosed hierarchical and declarative specification, the system maintains modularity thus reduces the growth of complexity.

The system leverages through a hierarchical set of skills. The skills are highly configurable tasks analogous to basic skills to a human who may learn skills in order to do a task. For example, a commonly used skill with the agents of the declarative agent service is collecting information from an end-user. Because these skills are highly configurable and form the foundation of all agents built with the AgentSDK, improvements to them are high-leverage as they provide benefits to an infinite number of applications built on them.

Additionally, because the disclosed method makes use of context provided hierarchically (e.g. exceptions), agents and functionality are composable. For example, one can build a component called OrderFind that leverages various inputs and chooses skills to narrow into a user's specific order with a variety of methods, and use this component in any number of workflows (e.g. Find order in order to return, Find order in order to track, Find order in to cancel, etc.). This level of composability is made possible and effective by the confluence of the declarative hierarchical syntax and the ability to have highly configurable components.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates one embodiment of a system environment for implementing a declarative agent service.

FIG. 2 illustrates one embodiment of modules of the declarative agent service.

FIG. 3A illustrates a process of using a large language model to classify conversations.

FIG. 3B provides an example code of usage of declarative syntax, in accordance.

FIG. 4 is a flowchart for a method of an agent deploying a hierarchical set of skill with a large language model to generate a response to a user input.

FIG. 5 is a block diagram illustrating components of an example machine able to read instructions from a machine-readable medium and execute them in a processor (or controller).

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

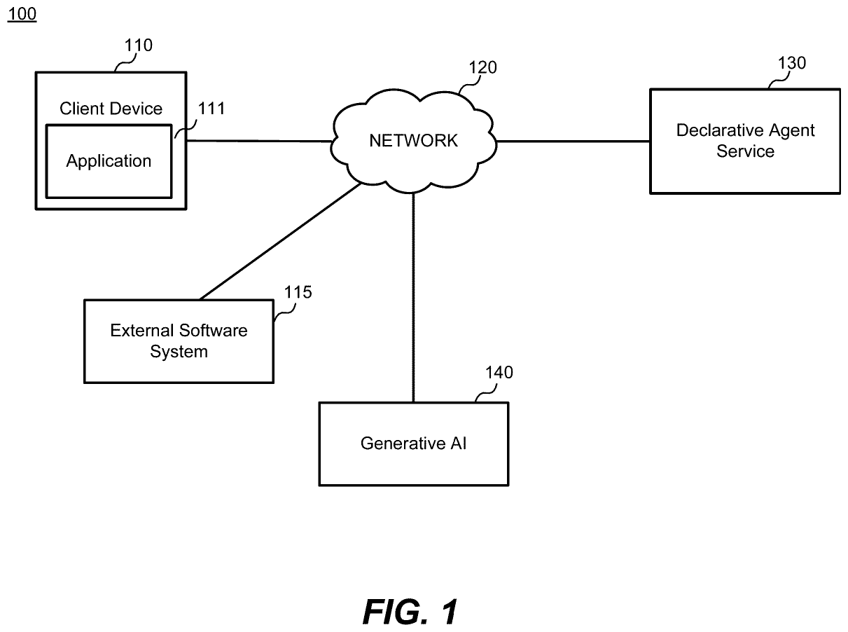

FIG. 1 illustrates one embodiment of a system environment for implementing a declarative agent service. As depicted in FIG. 1, declarative agent service environment 100 includes client device 110. While the declarative agent service environment 100 is only depicted with respect to one client device 110, this is for convenience only, and any number of client devices 110 may be interacting with declarative agent service 130. Client device 110 may be any device operated by an end-user having a user interface, such as a smartphone, a laptop, a personal computer, a wearable (e.g., smart watch), a kiosk, or any other electronic device capable of interfacing between a user and declarative agent service 130.

Declarative agent service 130 may be accessed by client device 110 using application 111. Application 111 may be an application dedicated to activities of declarative agent service 130 (e.g., an installed software package downloaded from declarative agent service 130 or an external repository such as an app store, or installed using other means such as a hard disk). Alternatively or additionally, application 111 may be a browser through which declarative agent service 130′s functionality may be accessed (e.g., directly, or indirectly through an embedded portal in a website of a third party company).

External software system 115 may be a software system of, e.g., a platform that utilizes declarative agent service 130. External software system 115 may require human intervention or may be utilized without a human in the loop, and may be configured to provide functionality, such as chatbot (interchangeably used with “chat automation system”) functionality to users of the platform. Client device 110 may be used by an entity controlling external software system 115 to communicate to declarative agent service 130 information sufficient to deploy classifications and skills and/or may be used by end-users interacting with external software system 115 to resolve and otherwise chat through an issue.

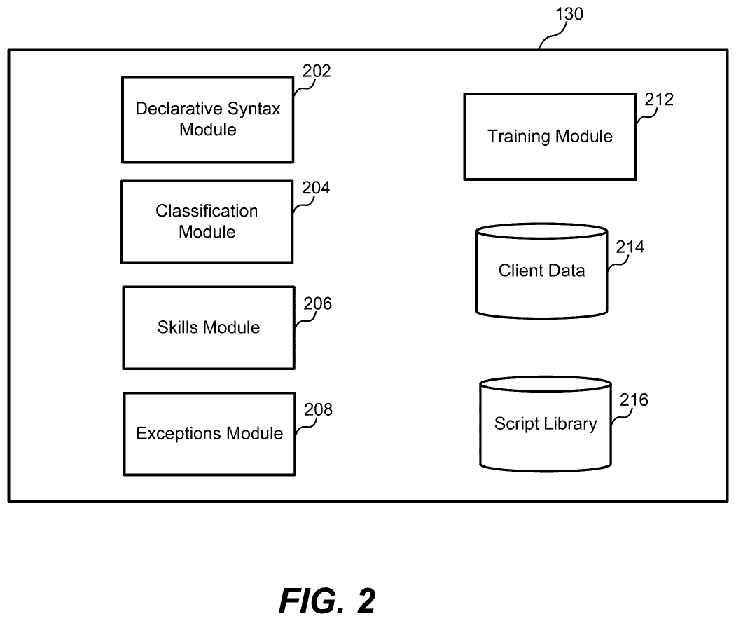

Declarative agent service 130 is used by client devices 110 and/or external software system 115 to provide a chat interface that addresses inquiries by users or by the platform of an external software system. Declarative agent service 130 is instantiated on one or more servers, accessible by way of network 120. Some or all functionality of declarative agent service 130 described herein may be distributed or fully performed by application 111 on a client device, or vice versa. Where reference is made herein to activity performed by application 111, it equally applies that declarative agent service 130 may perform that activity off of the client device, and vice versa. Declarative agent service 130 may be provided as a software development kit (SDK) to a client device or external software service to enable these entities to build the functionality of declarative agent service 130 on-premises. The SDK may export an API such that third parties (e.g., client devices or external software services) can specify their agents. Agent code using the SDK API is then uploaded to declarative agent service 130, on which it can execute (and run as an agent). Further details about the operation of declarative agent service 130 are described below with reference to FIG. 2.

Generative AI 140 may be part of declarative agent service 130 or may be a third-party provider that provides generative AI for processing natural language queries. The Generative AI 140 receives requests from the declarative agent service 130 to perform tasks using machine-learned models. The tasks include, but are not limited to, natural language processing (NLP) tasks, audio processing tasks, image processing tasks, video processing tasks, and the like. In one embodiment, the machine-learned models deployed by the Generative AI 140 are models configured to perform one or more NLP tasks. The NLP tasks include, but are not limited to, text generation, query processing, machine translation, response generation, chatbots, and the like. The Generative AI 140 may include one or many LLMs, the LLMs provided by any number of providers. In one embodiment, the LLM is configured as a transformer neural network architecture. For instance, a transformer model is coupled to receive sequential data tokenized into a sequence of input tokens and generate a sequence of output tokens depending on the task to be performed.

FIG. 2 illustrates one embodiment of modules of the declarative agent service. As depicted in FIG. 2, declarative agent service 130 includes declarative syntax module 202, classification module 204, skills module 206, exceptions module 208, a training module 212, a data store 214, and a script library 216. These modules and databases are merely illustrative; fewer or more modules and/or databases may be used to achieve the functionality disclosed herein.

Declarative syntax module 202 provides syntax for specifying sub-modules of an agent's behavior. The declarative syntax module 202 provides a structured syntax for modular development and defines a hierarchical structure of classification of user input and skills deployed by the declarative agent service 130. Developers may specify rules for activating specific sub-modules, depending on factors such as user intent, conversational context, or metadata like user preferences. In some embodiments, the declarative syntax module 202 may define each sub-module with standardized interfaces, including inputs (e.g., user queries or session variables) and outputs (e.g., responses or actions). Multiple sub-modules may be combined to fulfill complex tasks, with syntax supporting triage, guardrail, exception, sequences, priorities, and/or fallback mechanisms.

The classification module 204 that classifies a user input into one or more categories. The user input may be text messages or voice signals. In some embodiments, the classification module 204 may deploy a triage technique. The triage technique refers to the process of sorting and classifying the user input so that the user input can be routed to an accurate classification and/or be addressed by the skills module 206 efficiently. For example, where an agent is interacting in a chatbot capacity with a user of client device 110, given messages from the user and possible options, classification module 204 uses the triage technique to determine which category best matches the user's intent, query, task and the like. In some implementations, the triage technique may be configured by an entity controlling external software system 115 to define the categories that match what an end-user is seeking assistance on, and child classifications that define one or more skills that are to be used to handle further conversation relating to a corresponding category. In one example, the categories may may be organized in a hierarchical taxonomy including a plurality of root classifications. Each classification may further include a plurality of child classification. The root classifications form the foundation of the taxonomy, representing high-level categories that are broad to cover major areas of issues and provide a starting point for classification. For example, in a customer service context, root classifications may include “product issues,” “fraud and security,” “technical support,” or “knowledge base and response,” etc. The child classifications build upon the root classifications and correspond to specific subcategories nested under each root. In some implementations, a child classification may further include lower-level categories, e.g., grandchild classification, and so on to an optionally lower depth. For instance, under a root classification “technical support,” a child classification may include “program installation,” and a grandchild classification under this child classification may be “system compatibility.”

In some embodiments, the triage technique may include an LLM (e.g., generative AI 140). The classification module 204 uses the LLM to map a user input to at least one of the categories. In one example, when receiving a user input, the classification module 204 may generate a prompt to the LLM using the user input. In one example, the prompt may include at least the user input and a set of pre-defined categories. The pre-defined categories may be defined and customized by an external software system 115 or an organization that operates the 115. In some implementations, the set of pre-defined categories may have a hierarchical taxonomy structure. The prompt may include a specification of the set of categories, and the specification may include definitions, descriptions, and/or examples of the corresponding categories. For example, a specification corresponding to a set of categories may include descriptions of various types of returns (“return damaged item”, “return item purchased in-store”, “return item purchased online”, “return brand new item”). The classification module 204 may generate a prompt including the user input and these descriptions so that the LLM may match a wide range of user input. When a user sends a message such as “I'd like to return my shoes”, the classification module 204 generates a prompt including the message and the category descriptions and sends the prompt to the LLM to classify the message to at least one of the categories. In some embodiments, as the LLM processes the user input, the LLM doesn't just assign a single category. The LLM may classify the user input in an incremental manner, refining the classification as the LLM processes the user input though different levels of the hierarchical taxonomy. For instance, the LLM may first try to classify a user input into a broad root classification, such as “product issues,” “fraud and security,” “technical support,” or “knowledge base and response.” After assigning a root classification, the LLM may then look at the child classifications within that root classification. For example, under “product issues,” the user input may be further refined into “defective product” or “missing parts” based on the content of the user input.

In some implementations, the classification module 204 encodes the input into a set of input tokens and applies the LLM to generate a set of output tokens. Each token in the set of input tokens or the set of output tokens may correspond to a text unit. For example, a token may correspond to a word, a punctuation symbol, a space, a phrase, a paragraph, and the like. For an example query processing task, the LLM may receive a sequence of input tokens that represent a query and generate a sequence of output tokens that represent a response to the query.

In some embodiments, the classification module 204 uses the LLM with an auto-regressive approach to generate tokens. An auto-regressive LLM may predict a next token in a sequence based on previously generated tokens. The LLM may generate output tokens sequentially, starting with an initial input (e.g., a user input) and gradually producing more tokens that refine the output as the process goes. For instance, initially, the LLM may start with a root classification like “technical issue” for classifying a user input. The first token may help the LLM decide whether it is an issue with software or hardware. As the LLM generates more tokens, the LLM uses the previous tokens as context to further narrow down the classification to child classifications (e.g., “broken screen” vs. “software crash”), gradually eliminating less likely categories and zeroing in on the most appropriate classification. In some embodiments, the LLM may iteratively go through the hierarchical classifications until a final child classification is encountered. In each iteration, the prompt to the LLM may be updated to include the user input, the hierarchical categories, and the tokens generated in the previous iterations. The final child classification may be the most specific classification that the LLM can generate based on the user input.

In some implementations, the classification module 204 may key each category with a token in alternating numeric and alphabet characters, so that at each step in the token generation the LLM narrows semantically into the user's intent. In one example, the classification module 204 may generate an identifier representing each category with a specific pattern of numbers (e.g., 1, 2, 3, etc.) and letters (e.g., A, B, C, etc.) For example, in a traditional numbering scheme, a set of categories may be identified as: 1) Return brand new item; 2) Return damaged item; 3) Return item purchased online; 4) Return item purchased elsewhere; 5) . . . ; 40) File a warranty claim. Under this scheme, the LLM may be required to pick between 40 next possible tokens when attempting to classify the user input (since numbers 1-40 are all 1 token). The classification module 204, as disclosed herein, labels the set of categories with a hierarchical structure such that each token may be used to incrementally refine the classification. For example, the classification module 204 may use a number scheme, such as: A1) Return brand new item; A2) Return damaged item; A3) Return item purchased online; A4) Return item purchased elsewhere; B1) . . . ; G1) File a warranty claim, etc. In this example, the number of tokens the LLM has to choose between is limited to A-G (e.g., root classifications), and if the LLM chooses “A,” then the next possible tokens to be output by the LLM may be limited to 1-4 (e.g., child classification under “A”). By deploying the triage technique in this manner, the process that the classification module 204 determines a match of the user input to candidate categories may be reduced by an order of magnitude or more while reducing noise that influences inaccuracies.

In some embodiments, the classification module 204 may prompt the user with clarifying questions and performs prioritization according to defined heuristics. In some examples, the user input may be unclear, incomplete, or ambiguous, making it difficult for the classification module 204 to confidently assign a category. To improve accuracy, the classification module 204 identifies gaps in information and asks the user clarifying questions before proceeding with classification. The classification module 204 may identify gaps in information by analyzing user input and comparing it against predefined criteria, expected data structures, or learned patterns of the pre-defined categories. In some embodiments, the classification module 204 may evaluate the classification output from the LLM, for example, based on specific thresholds and conditions, including confidence scores, ambiguity detection, and predefined rules. In one example, the classification module 204 uses a confidence score to determine a confidence level of the classification of the user input. If the confidence score falls below a predefined threshold (e.g., 70%), the classification module 204 considers the classification uncertain and prompts the user with a clarifying question. For instance, if a user says, “I need help with billing,” and the system assigns 60% confidence to “Billing Dispute” and 40% confidence to “Payment Failure,” the classification module 204 may generate a clarifying question, “Are you disputing a charge or experiencing a payment failure?” In some implementations, the classification module 204 may generate clarifying questions using different approaches, ranging from predefined rule-based methods to more machine learning techniques.

In some embodiments, the classification module 204 may deploy guardrails when using the LLM to classify intent of an end-user. Guardrails may refer to predefined categories, rules, constraints, or safety mechanisms that override or guide the LLM's classification. In one implementation, the classification module 204 may define guardrails based on situations where the set of categories may not align with pre-defined criteria. These scenarios typically include cases where sentiment, compliance, or priority considerations take precedence over a purely topic-based classification.

In some embodiments, the classification module 204 may establish specific rules and conditions that dictate when a guardrail should override an LLM classification. For example, the classification module 204 may determine the rules based on keyword matching, sentiment analysis, contextual cues, compliance triggers, etc. For instance, if an input contains strong dissatisfaction indicators such as “unhappy,” “frustrated,” or “not acceptable,” the classification module 204 may automatically classify it under “Dissatisfaction” rather than its originally assigned category. By defining these conditions, the classification module gains a structured mechanism for refining LLM output and ensuring proper categorization.

For example, while the LLM analyzes the term “return” and will output an initial classification in category A, the external software system 115 may deploy a sentimental trigger, e.g., a “dissatisfaction” guardrail, where when a user expresses dissatisfaction, the user is directed to a certain outcome (e.g., a human representative or some other intervention). The classification module 204 determines a “Dissatisfaction” guardrail based on the sentimental trigger. When such a guardrail is deployed, “I am dissatisfied with the return process” may be categorized by the “Dissatisfaction” guardrail despite it matching the Return category “A”.

### Clustering Algorithm

Over time, new topics, technologies, and user concerns emerge that may not be captured within the existing category structure. For example, a sudden spike in inquiries related to a new product launch, software update, or industry event may indicate the need for a new category. By dynamically identifying these shifts, the classification module 204 remains relevant and can quickly adjust to changing needs without requiring extensive manual intervention. In some embodiments, the classification module 204 may determine a category of a user input by matching the user input with existing categories or suggesting new categories. The classification process may require recomputing existing categories and backfilling new categories to ensure all data aligns with the updated classification schema. By continuously adapting to new data and refining categories, the classification module 204 maintains a dynamic, organized, and accurate classification of user interactions.

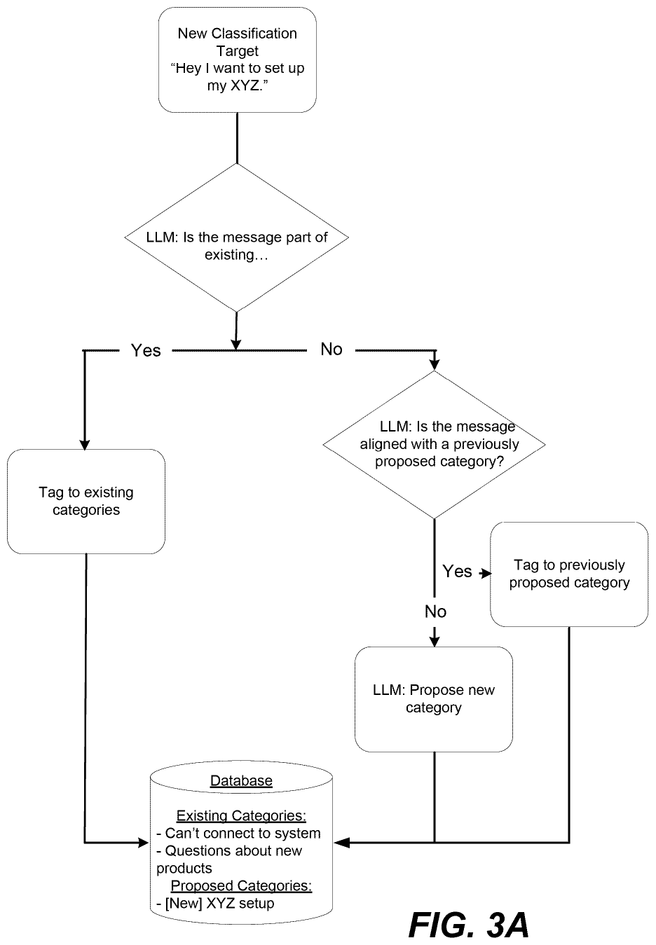

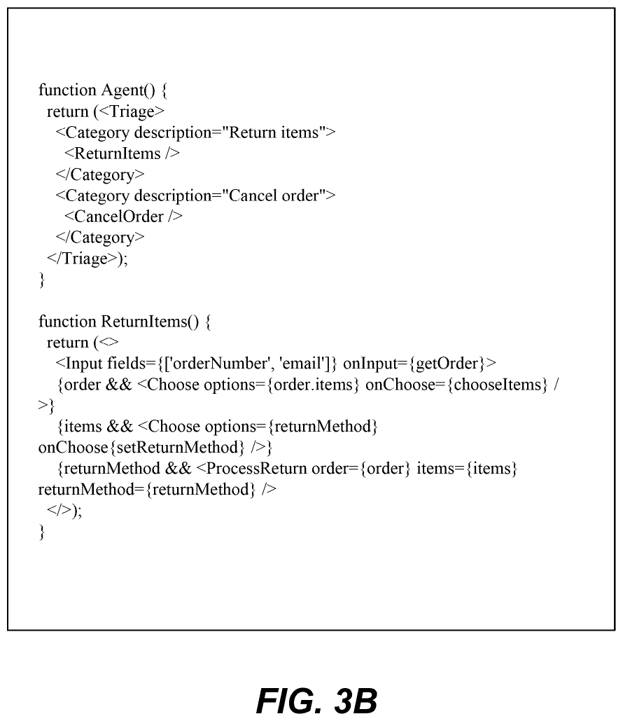

FIG. 3A illustrates a process of using LLM to classify conversations. For instance, an agent receives a new message (e.g., a new classification target) from a user, “Hey, I want to set up my XYZ.” The agent receives the input and uses an LLM (e.g., Generative AI 140) to determine whether the message can be classified into an existing category. If the message can be classified into an existing category, such as “Account Setup” or “Installation Instructions,” the LLM outputs a tag and the agent tags the conversation with the identified existing category. If the LLM cannot identify an existing category to classify the conversation, the LLM may determine whether the message is aligned with a previously proposed category. If an aligned previously proposed category is identified, the LLM outputs the tag of the previously proposed category and the agent tags the conversation with the previously proposed category. If an aligned previously proposed category is not identified, the LLM may output a proposed new category for tagging the conversation. In some implementations, a human agent may receive the new category and evaluate whether the new category is valid, actuate, etc. The tagged conversation and the corresponding tag are stored in a data store 214 which is accessible by the LLM in subsequent clustering steps. The data store 214 may include both existing categories and the proposed categories, and the proposed categories may include both the previously proposed categories and the newly proposed categories.

In some embodiments, the classification module 204 may use an LLM with a clustering algorithm for the classification. The classification module 204 may generate one or more embeddings to represent the user input and determines a category of the user input by clustering the respective embeddings. Embeddings are dense vector representations of words, sentences, documents, etc. that capture semantic relationships in a continuous vector space. To generate embeddings, the classification module 204 may use text vectorization that transforms textual data into a numerical format that the LLM can understand and process. In some implementations, the classification module 204 may pre-process the text data, such as removing punctuation, special characters, etc., and normalize the text data to generate the embeddings. The classification module 204 uses the LLM to convert the pre-processed text data to embeddings. In some examples, the LLM may include different embedding models, such as Word2Vec, Universal Sentence Encoder (USE), Bidirectional Encoder Representations from Transformers (BERT), etc. The LLM may apply different embedding models depending on the complexity and size of the conversation, for example, whether the conversation is a sentence, a paragraph, or the user input includes a document, and the like. In some embodiments, the generated embeddings may reflect the user intent associated with the conversation. The LLM may analyze the contextual information included in the context to understand the user intent. For example, the user input “I want to set up XYZ” implies a setup or configuration action, which needs to be encoded as a specific type of intent. The embedding will reflect this intent by positioning the sentence in a region of the vector space that represents setup or installation intents. In another example, two sentences may have similar wording but different intents, leading to different embeddings. For example, “I want to set up XYZ” (intent to configure something) versus “I want to learn about XYZ” (intent to gain information) Although both sentences are about “XYZ,” their different intents will result in embeddings that capture distinct meanings.

Based on the generated embeddings, the classification module 204 may cluster the conversations into different categories. Conversations with similar intents (like “setting up” or “configuration”) will have similar embeddings, leading them to be clustered together in the same category which aligns with the user's needs and actions. Embeddings help differentiate conversations with distinct intents, ensuring that different categories represent different types of interactions. For instance, a conversation with the intent of troubleshooting will be clustered separately from one with a purchase intent. In some embodiments, the classification module 204 may cluster the embeddings based on a distance between two embeddings, and the distance may indicate the similarity of the represented conversations. For instance, the classification module 208 determines a threshold distance. If two embeddings have a distance that is within the threshold distance, the conversations represented by these two embeddings may be considered as similar and clustered into a same category. In other embodiments, the classification module 204 uses K-means clustering to cluster conversations based on the embeddings. Various other methods, algorithms, and models may be used to determine the distance between the embeddings and the similarity between the chunks of code. In some implementations, the classification module 208 may define cluster granularity to adjust the categories. Cluster granularity refers to the level of detail or specificity represented in the clusters formed by a clustering algorithm. The cluster granularity may determine how finely or coarsely the data is grouped into categories. Fine granularity involves creating a large number of smaller, more specific categories, and each category captures a narrow and detailed segment of the data. Alternatively, coarse granularity involves creating fewer, larger categories, and each category represents a broader grouping of data points that share more general characteristics. In some implementations, the classification module 208 may choose the granularity by adjusting the clustering algorithms, such as, threshold of distances between two similar embeddings.

In some embodiments, when receiving a new user input/conversation, the classification module 204 may use the LLM which includes the one or more clustering methods to identify a classification of the new user input/conversation. For example, the LLM may identify a similarity of the embedding that represents the new user input with embeddings of existing categories. If the LLM determines the similarity of the embedding meets a certain threshold, the LLM may classify the new user input to the identified existing category, e.g. tagging the user input with the existing category. In some examples, the LLM may determine that the new user input does not match any existing categories, the LLM may determine whether the new user input aligns with a previously proposed category. The previously proposed categories are categories that have been suggested based on past conversations but are not yet fully established. In some implementations, the previously proposed categories may be stored in data store 214, for example, represented by embeddings. The LLM may retrieve the stored embeddings that represent the previously proposed categories and match the new user input with the previously proposed categories. If the input matches a previously proposed category, the LLM tags the conversation accordingly. In addition to using embeddings, various other methods, algorithms, and models may be used to match and/or determine the previously proposed categories, for example, keyword matching, semantic similarity, and contextual analysis, and the like.

In some embodiments, the LLM may determine that the new user input does not align with either an existing or a previously proposed category, the LLM will propose a new category based on the content of the new user input. For instance, if “XYZ” is a newly launched product and “set up” does not correspond with any existing setup-related categories, the LLM may propose a new category like “XYZ Setup Requests.” In some implementations, the proposed category may be sent to a human agent who may evaluate the validity and accuracy of this new category to ensure it appropriately reflects the conversation's intent and content. This human-in-the-loop approach ensures that the categorization process remains accurate and relevant, refining the database as new types of inquiries are identified.

Once the conversation is tagged, either with an existing, proposed, or new category, both the conversation and its corresponding tag are stored in the data store 214. This data store 214 is accessible by the LLM for future reference, allowing the LLM to continuously learn from past interactions and improve its categorization accuracy over time. This iterative process helps maintain an up-to-date, organized classification that adapts to evolving user needs and queries.

In some embodiments, the classification module 204 may periodically update the categories based on the most recent data and/or refine categories through light human configuration and customer feedback. The classification module 204 may include a recomputing cluster history with a rolling window which continuously updates and recalculates clusters/categories of data over a specified time frame. A rolling window may be used to analyze and update the categories based on most recent data while removing old data outside the window. The categories may be recomputed regularly, using only data within the most recent time window. The categories may be updated dynamically, and as new data comes in, older data falls out of the window. In some examples, the categories may be updated in real time. By continuously recalculating categories, the classification module 204 can adapt to emerging trends, shifts in customer behavior, or changes in conversation topics, maintaining the relevance of the categories. The classification module 204 may limit the number of additional categories to around a certain number, e.g., 10, 20 or so. As the rolling window moves forward and new data comes in, some categories that are no longer relevant or less frequently occurring will “roll off,” e.g., removed from the data store 214.

Referring back to FIG. 2, depending on the classification performed by the classification module 204, the skills module 206 determines one or more skills to deploy. The skills module 206 may access a set of pre-defined skills and selects one of the sets of pre-defined skills based on the category of the user input. In some implementations, the set of pre-defined skills may be written in program code and stored in script library 216. In some implementations, the skills may include LLM calls invoking a LLM to perform a specific task or generate a response. The skills module 206 may map each category, e.g., root classification, or child classification in the hierarchical taxonomy with a skill to instruct how the agent should process and respond to the user input. The mapping between categories and skills ensures that the chatbot selects the most appropriate method for generating a response based on the user's intent. In some cases, the set of skills may be organized in a hierarchical structure corresponding to the matched categories respectively.

In some embodiments, the skills module 206 may deploy an input skill. The input skill collects some set of inputs from the user and verifies whether the user input meets predefined validation rules. An exemplary end-to-end flow of an input skill may include collecting an order number and email address. The input skill may be implemented with the name and description of the fields in question and a code (e.g., JavaScript) function to validate the inputs. In some implementations, the input skill may include invoking LLM calls so that the skills module 206 may apply an LLM to perform tasks associated with the input skill. In one example, the skills module 206 deploys an input skill to extract the fields in question from the entire conversation between the user and the agent. In some cases, the information may have already been provided by the user before, the skills module 206 may extract the information, for example, from the user data that is stored at the data store 214. In this way, the skills module 206 avoids unnecessary conversation, improves overall efficiency, and reduces network transmissions. Responsive to extracting a value for every requested field, the input skill runs a “provide validation function” which in this example scenario attempts to lookup an order. Responsive to detecting a problem with the extracted information, the skills module 204 may feed an error message back into the input skill which will use the validation error to steer further conversation and extraction.

In some examples, after extraction, the skills module 206 may trigger the classification module 204 to run a classification to determine the state of the conversation with regards to the user input. For example, the skills module 206 determines whether the agent has yet asked for the requested information or whether the user is attempting to provide it or has refused. After the skills module 206 has determined the state of the conversation, the skills module 206 may proceed to generate an agent response. The agent response may be prompting the user to provide the order number and email or in the case of a validation error, prompting the user to double check their information as the agent was unable to locate an order with that information.

In some embodiments, the skills module 206 may deploy a choose skill, which presents some options to a user and through dialog determines their intended choice. Instead of extracting free-form text from the conversation, when deploying a choose skill, the skills module 206 may use an LLM to generate a specified set of options or pick from a specified set of options. As a consequence of having a fixed set of options, when there is ambiguity, the skills module 206 instructs the LLM to clarify between the items among which there is ambiguity.

In some embodiments, the skills module 206 may deploy a respond skill, which re-formulates deterministically computed information or question to the context of the conversation. In some examples, the respond skill may take as input either a message to paraphrase or an instruction to the LLM on how to respond. The skills module 206 generates a prompt to an LLM by combining the message and the history of the conversation and/or the extracted context to make an LLM call to generate an agent response. In some embodiments, the respond skill is both a top-level skill used to provide information to a user, as well as used within other skills to aide in the generation of agent responses.

In some embodiments, the skills module 206 may deploy an instruction skill, which instructs the user to perform some action and seek confirmation. The instruction skill requires the user to confirm understanding or action. In some examples, the instruction skill may be implemented by using the respond skill to generate the instruction, and then on the subsequent user input, the classification module 204 uses an LLM with a binary classifier to determine if the user has acknowledged the instruction before proceeding.

As the agent of the declarative agent service 130 provides the generated response to the user and as the conversation progresses, the user may provide subsequent input that requires the agent to go through the process again. Based on the subsequent user input, the classification module 204 may invoke the LLM again to re-classify the subsequent user input. Based on the new classification, the skills module 206 may deploy a different skill and generate a new response, taking into account the new context. The conversation may continue in this iterative manner, with each new user input leading to another round of classification, skill deployment, and response generation.

The exceptions module 208 detects an exception during a conversation and interrupts or modifies the flow of the conversation. An exception may refer to an event or condition that disrupts the normal flow of hierarchical components (e.g., hierarchical classification and/or hierarchical skills) in the declarative agent service 130. An exception may be introduced by unpredictable user behavior, invalid inputs, or system failures. For example, a user may abruptly change the topic in a conversation, the classification module 204 may determine a guardrail category for a user input, or the agent's response violates certain pre-defined rules (e.g., hallucination). The exceptions module 208 may maintain a set of pre-defined exceptions, each exception may be associated with a specification describing the event or condition corresponding to the exception. The exceptions module 208 may determine a set of pre-defined exception activities. An exception activity is a mechanism or fallback designed to address an exception. When detecting an exception, the exceptions module 208 may stop the currently deployed skill and switch to a pre-defined exception activity that is designed to manage the corresponding exception. In some implementations, the exceptions module 208 may detect an exception when a conversation deviates from the expected behavior or disrupts the normal flow of the hierarchical components. In some examples, the detection of an exception may include monitoring for specific error conditions, ambiguous inputs, or unexpected states during the conversation.

In some embodiments, at each round of a conversation, as the user inputs a new message, the classification module 204 classifies the new input to one of the hierarchical categories, and the skills module 206 deploys one of hierarchical skills corresponding to the classified category. In the meanwhile, the exceptions module 208 may detect an exception by analyzing the user input, determined category and skill in this round with respect to the user input and determined category and skill in previous rounds of the conversation. For instance, an agent for a web platform receives a user input which requests an update of a software program. This software update process may include collecting several pieces of information, such as software program type, account, which version they wish to update, which system the software program is installed, etc. The classification module 204 and skills module 206 of the declarative agent service 130 classify the user inputs and deploy corresponding skills to implement the update process. During the process, the user may change their mind and wish to install a new software program instead. In this case, the exceptions module 208 may detect this situation as an exception. The exceptions module 208 may define the exception with a specification and a corresponding exception activity. For example, the exceptions module 208 may define the exception as “the user wishes to install a different software program instead of updating an older version” along with an alternate component “Install” to handle this flow. As a consequence of specifying this exception, at each turn of the conversation, the exceptions module 208 may determine if this exception has occurred and re-route the conversation to the appropriate component. Note that the components in the subtree of the “Update” component need not be aware of this exception since it's provided hierarchically and inherited by all child components.

In some embodiments, the exceptions module 208 may deploy a second LLM to determine whether an exception has occurred. As an example, a guardrail may be configured to prevent medical advice from being dispensed as an answer, and a violation of this guardrail may be defined as an exception. The declarative agent service 130 may deploy a chain of calls to one or more LLMs to perform a set of skills in response to a user's query, and the exceptions module 208 may apply the output of those calls to a second LLM to determine whether the guardrail is violated, i.e., whether the pre-defined exception has occurred. In the case of medical advice, where the output includes information related to medical advice, the exceptions module 208 may prevent the output from being made and may deploy other skills to obtain the correct answer or may have the second LLM re-perform the skills or generate an output that scrubs out the medical advice.

In some embodiments, the exceptions module 208 may define an LLM generated hallucination as an exception. The exceptions module 208 may define a set of facts derived from the conversation so far and/or from the state of the conversation. The exceptions module 208 generates a prompt to a second LLM using the set of facts. The prompt includes a request that facts within the primary LLM's response should be evaluated for consistency against elements of the conversation so far and any other fact base (e.g., the policies of the entity deploying the conversation agent). The exceptions module 208 input the prompt to the second LLM to determine whether the response prepared by the primary LLM includes any hallucination. For example, if the primary LLM's response is “Hi John Doe, Thanks for your message,” the secondary LLM may evaluate and determine that the user never indicated their name, and therefore the name “John Doe” was hallucinated. In this case, the exceptions module 208 determines an exception occurs and performs an exception activity, e.g., modifying the response by removing “John Doe.”

The model training module 212 trains machine-learning models used by the declarative agent service 130. The declarative agent service 130 may use machine-learning models to perform functionalities described herein. In some implementations, the machine-learning model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions.

In one embodiment, the language models are large language models (LLMs) that are trained on a large corpus of training data to generate outputs for the NLP (natural language processing) tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the declarative agent service 130 or one or more entities different from the declarative agent service 130, e.g., Generative AI 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one embodiment, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In some embodiments, the model training module 212 may upgrade the model architecture and fine-tune the models with domain-specific data, context, user intent, etc. In some implementations, the model training module 212 may incorporate a feedback loop where mismatched categories are analyzed and used to retrain or adjust the model. In some examples, a human operator may review the output, the mismatched categories, and/or the conversation scripts, and identified errors. The human operator may modify labels of the training examples. A human operator may identify cases where the model fails to meet expectations, such as generating incorrect or incomplete categories. These cases can then be added to the training dataset with proper corrections, allowing the model to learn from its mistakes.

The model training module 212 may apply an iterative process to train a machine-learning model whereby the model training module 212 updates parameter values of machine-learning models based on each of the set of training examples. The training examples may be processed together, individually, or in batches. To train a machine-learning model based on a training example, the model training module 212 applies the machine-learning model to the input data in the training example to generate an output based on a current set of parameter values. The model training module 212 scores the output from the machine-learning model using a loss function. A loss function is a function that generates a score for the output of the machine-learning model such that the score is higher when the machine-learning model performs poorly and lower when the machine-learning model performs well. In cases where the training example includes a label (e.g., a root classification “billing and payments”, a child classification “payment failed”, etc.), the loss function is also based on the label for the training example. Some example loss functions include the mean square error function, the mean absolute error, hinge loss function, and the cross-entropy loss function. The model training module 212 updates the set of parameters for the machine-learning model based on the score generated by the loss function. For example, the model training module 212 may apply gradient descent to update the set of parameters.

The model training module 212 may use the historical conversation to prepare a training dataset to train a machine learning model. The model training module 212 may preprocess the text (or text transcribed from voice) in the conversation, for example, by removing irrelevant content and standardizing text formats. Conversations are segmented into manageable units, and labeled with categories, exceptions, guardrails, etc. Text data is then converted into numerical representations using techniques like tokens, word embeddings or contextual embeddings. The user related background information may also be extracted and labeled. In some embodiments, the model training module 212 may use a language model to simulate user-agent conversations and use the simulated conversations to generate training dataset. In some implementations, the model training module 212 may use a language model to simulate user actions and responses to an agent of the declarative agent service 130. For example, the simulated users are seeded with specific instructions to create a realistic simulation that mirrors human behavior across various dimensions, e.g., adding exceptions. These instructions may outline task-specific constraints and the specific task to be completed. For example, the task-specific constraints may include limitations like triggering guardrail languages, user changing queries, and the like. These instructions guide the training of the machine learning models (e.g., LLMs) in accurate classification and generating consistent responses. The model training module 212 feeds the training data into the model, where it learns to determine categories and skills and detect guardrails and exceptions.

In some embodiments, configuring guardrails and categories skills used by the external software system 115 may be assisted using machine learning. For example, after a configuration is set, the declarative agent service 130 may apply the configuration and/or other auxiliary information to a supervised machine learning model, such as a convolutional neural network, a deep learning classifier, and so on. The machine learning model may output an identification of a gap in the categories and/or guardrails and/or recommendations for additional categories and/or guardrails. The machine learning model may be trained using training examples of configurations for similar purposes by other external software systems 115. In some embodiments, the training data may be labeled by additional categories and/or guardrails deployed after initial deployment, which may be indicative of gaps found following live use of the external software systems 115. The entity deploying the external software system 115 may select the recommendations to have them automatically added as additional categories and/or guardrails. Child classifications may be similarly recommended based on child skills indicated in the configuration data.

The data store 214 stores data used by the declarative agent service 130. For example, the data store 214 stores user data, previous conversation, etc. for use by the declarative agent service 130. The data store 214 also stores trained machine-learning models trained by the model training module 212. For example, the data store 214 may store the set of parameters for a trained machine-learning model on one or more non-transitory, computer-readable media. The data store 214 uses computer-readable media to store data and may use databases to organize the stored data. The data store 214 may store the pre-defined categories, skills, exceptions, exception activities, etc.

The script library 216 is a code library (e.g., a JavaScript library, though any code may be used) that specifies hierarchical components of an agent's behavior, such as classification, and specific skills. As an example, script library 216 may be a JSX (JavaScript XML) library. Each component may be responsible for a distinct task and may delegate to flexibly defined child components (lower in the hierarchy) for subsequent actions or behaviors. In some implementations, the script library 216 may organize the components hierarchically, with root components representing higher-level skills and child components implementing more granular or specific skills. For instance, a root component like “order processing” may include child components such as “order status” or “order returns,” each handling a distinct sub-skill. FIG. 3B provides an example code of usage of declarative syntax.

### Hierarchical Components With Large Language Models

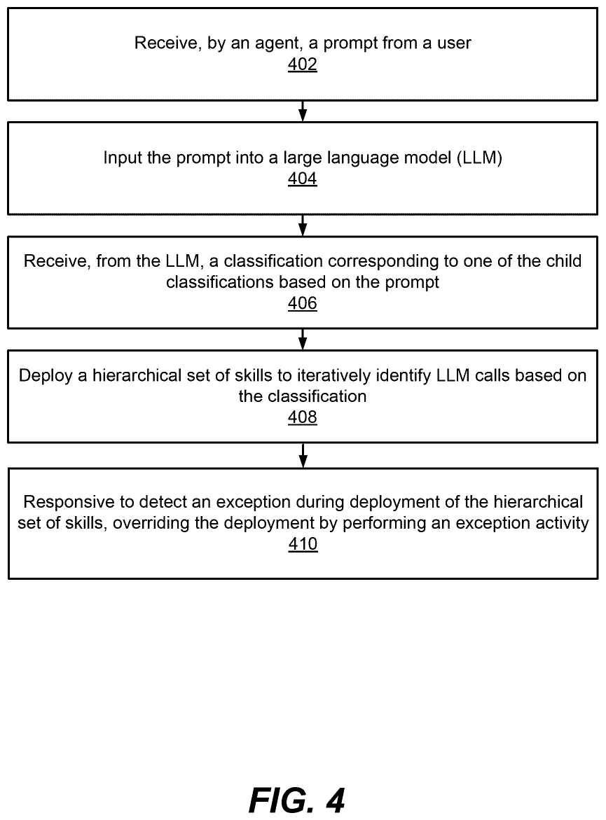

FIG. 4 is a flowchart for a method of an agent deploying a hierarchical set of skill with a large language model (LLM) to generate a response to a user input. Alternative embodiments may include more, fewer, or different steps from those illustrated in FIG. 4, and the steps may be performed in a different order from that illustrated in FIG. 4. These steps may be performed by a declarative agent service 130. In some embodiments, each of these steps may be performed automatically by the declarative agent service 130 without human intervention. In some embodiments, a human operator may perform one or more of the steps.

An agent of the declarative agent service 130 receives 402 a prompt from a user. The classification module 204 inputs 404 the prompt into an LLM. The LLM is trained using a taxonomy having a plurality of root classifications, and a set of child classifications under each root classification. In some embodiments, inputting the prompt into the LLM comprises an auto-regressive input that iteratively goes through hierarchical classifications until a final child node is encountered. The classification module 204 receives 406 a classification corresponding to one of the child classifications based on the prompt. The skills module 206 deploys 408 a hierarchical set of skills to iteratively identify one or more LLM calls based on the classification. The hierarchical set of skills may include a chain of two or more skills performed based on the classification. Responsive to detecting an exception during deployment of the hierarchical set of skills, the exceptions module 208 overrides 410 the deployment by performing an exception activity. In some embodiments, the exceptions module 208 may detect a hallucination made by the LLM using at least one additional LLM. In some embodiments, the exceptions module 208 may detect content in a response generated by the LLM that violates a guardrail.

### Computing Machine Architecture

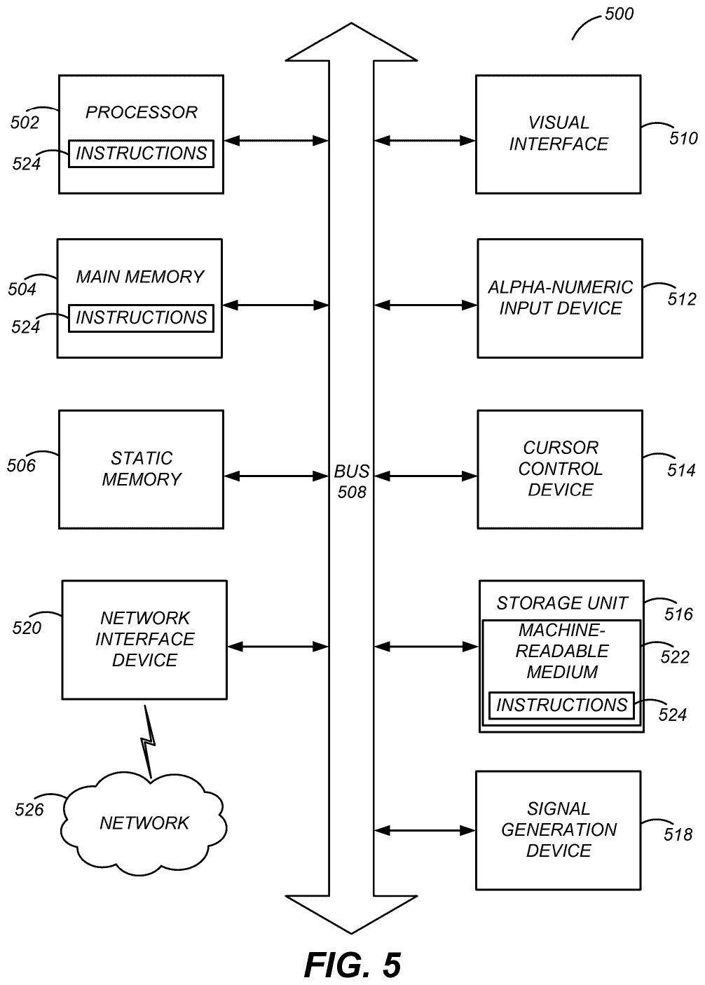

FIG. 5 is a block diagram illustrating components of an example machine able to read instructions from a machine-readable medium and execute them in a processor (or controller). Specifically, FIG. 5 shows a diagrammatic representation of a machine in the example form of a computer system 500 within which program code (e.g., software) for causing the machine to perform any one or more of the methodologies discussed herein may be executed. The program code may be comprised of instructions 524 executable by one or more processors 502. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a tablet, a web appliance, a network router, switch or bridge, or any machine capable of executing instructions 524 (sequential or otherwise) that specify actions to be taken by that machine. Further, while only a single machine is illustrated, the term “machine” shall also be taken to include any collection of machines that individually or jointly execute instructions 524 to perform any one or more of the methodologies discussed herein.

The example computer system 500 includes a processor 502 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 504, and a static memory 506, which are configured to communicate with each other via a bus 508. The computer system 500 may further include visual display interface 510. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 510 may include or may interface with a touch enabled screen. The computer system 500 may also include alphanumeric input device 512 (e.g., a keyboard or touch screen keyboard), a cursor control device 514 (e.g., a mouse, a trackball, a joystick, a motion sensor, or other pointing instrument), a storage unit 516, a signal generation device 518 (e.g., a speaker), and a network interface device 520, which also are configured to communicate via the bus 508.

The storage unit 516 includes a machine-readable medium 522 on which is stored instructions 524 (e.g., software) embodying any one or more of the methodologies or functions described herein. The instructions 524 (e.g., software) may also reside, completely or at least partially, within the main memory 504 or within the processor 502 (e.g., within a processor's cache memory) during execution thereof by the computer system 500, the main memory 504 and the processor 502 also constituting machine-readable media. The instructions 524 (e.g., software) may be transmitted or received over a network 526 via the network interface device 520.

While machine-readable medium 522 is shown in an example embodiment to be a single medium, the term “machine-readable medium” should be taken to include a single medium or multiple media (e.g., a centralized or distributed database, or associated caches and servers) able to store instructions (e.g., instructions 524). The term “machine-readable medium” shall also be taken to include any medium that is capable of storing instructions (e.g., instructions 524) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
receiving, by an agent, a prompt from a user;
inputting the prompt into a large language model (LLM), the LLM trained using a taxonomy having a plurality of root classifications, and a set of child classifications under each root classification;
receiving, from the LLM, a classification corresponding to one of the child classifications based on the prompt;
deploying a hierarchical set of skills to iteratively identify one or more LLM calls based on the classification; and
responsive to detecting an exception during deployment of the hierarchical set of skills, overriding the deployment by performing an exception activity.

2. The method of claim 1, wherein inputting the prompt into the LLM comprises an auto-regressive input that iteratively progresses through hierarchical classifications until a final child node is encountered.

3. The method of claim 1, wherein the hierarchical set of skills comprises a chain of two or more skills performed based on the classification.

4. The method of claim 1, wherein detecting the exception comprises detecting a hallucination made by the LLM using at least one additional LLM.

5. The method of claim 1, wherein detecting the exception comprises detecting content in a response generated by the LLM that violates a guardrail.

6. The method of claim 1, further comprising:
retrieving, from a database, a plurality of categories that classify conversations based on content of the conversations;
determining whether the prompt aligns with one of the plurality of categories;
responsive to determining that the prompt does not align with one of the plurality of categories, retrieving, from the database, a set of previously proposed categories;
determining whether the prompt aligns with one of the set of previously proposed categories;
responsive to determining that the prompt does not align with one of the set of previously proposed categories, providing the prompt to the LLM to generate a new category for classifying the prompt;
receiving output from the LLM, the output comprising at least one recommended category; and
tagging the prompt with the at least one recommended category from the output.

7. The method of claim 6, wherein determining whether the user prompt aligns with one of the plurality of categories comprise:
generating a prompt embedding representing the user prompt;
retrieving a plurality of category embeddings each represents a respective category; and
determining a similarity between the prompt embedding with one or more of the plurality of category embeddings.

8. The method of claim 7, wherein the LLM is trained by: accessing a plurality of training examples, each training example including a conversation between an agent and a user, wherein the conversation is generated by an additional large language model.

9. A non-transitory computer readable storage medium comprising stored program code, the program code comprising instructions, the instructions when executed causes a processor system to:
receive, by an agent, a prompt from a user;
input the prompt into a large language model (LLM), the LLM trained using a taxonomy having a plurality of root classifications, and a set of child classifications under each root classification;
receive, from the LLM, a classification corresponding to one of the child classifications based on the prompt;
deploy a hierarchical set of skills to iteratively identify one or more LLM calls based on the classification; and
responsive to detecting an exception during deployment of the hierarchical set of skills, override the deployment by performing an exception activity.

10. The non-transitory computer readable storage medium of claim 9, wherein inputting the prompt into the LLM comprises an auto-regressive input that iteratively processes through hierarchical classifications until a final child node is encountered.

11. The non-transitory computer readable storage medium of claim 9, wherein the hierarchical set of skills comprises a chain of two or more skills performed based on the classification.

12. The non-transitory computer readable storage medium of claim 9, wherein the instructions to detect the exception further cause the processor system to:
detect a hallucination made by the LLM using at least one additional LLM.

13. The non-transitory computer readable storage medium of claim 9, wherein the instructions to detect the exception further cause the processor system to:
detect content in a response generated by the LLM that violates a guardrail.

14. The non-transitory computer readable storage medium of claim 9, wherein the instructions further cause the processor system to:
retrieve, from a database, a plurality of categories that classify conversations based on content of the conversations;
determine whether the prompt aligns with one of the plurality of categories;
responsive to determining that the prompt does not align with one of the plurality of categories, retrieve, from the database, a set of previously proposed categories;
determine whether the prompt aligns with one of the set of previously proposed categories;
responsive to determining that the prompt does not align with one of the set of previously proposed categories, provide the prompt to the LLM to generate a new category for classifying the prompt;
receive output from the LLM, the output comprising at least one recommended category; and
tag the prompt with the at least one recommended category from the output.

15. The non-transitory computer readable storage medium of claim 14, wherein the instructions to determine whether the user prompt aligns with one of the plurality of categories further cause the processor system to:
generate a prompt embedding representing the user prompt;
retrieve a plurality of category embeddings each represents a respective category; and
determine a similarity between the prompt embedding with one or more of the plurality of category embeddings.

16. The non-transitory computer readable storage medium of claim 15, wherein the LLM is trained by: accessing a plurality of training examples, each training example including a conversation between an agent and a user, wherein the conversation is generated by an additional large language model.

17. A computer system comprising:
one or more processors; and
a non-transitory computer-readable storage medium storing instructions that, when executed by a processor, cause the processors to:
receive, by an agent, a prompt from a user;
input the prompt into a large language model (LLM), the LLM trained using a taxonomy having a plurality of root classifications, and a set of child classifications under each root classification;
receive, from the LLM, a classification corresponding to one of the child classifications based on the prompt;
deploy a hierarchical set of skills to iteratively identify one or more LLM calls based on the classification; and
responsive to detecting an exception during deployment of the hierarchical set of skills, override the deployment by performing an exception activity.

18. The computer system of claim 15, wherein inputting the prompt into the LLM comprises an auto-regressive input that iteratively processes through hierarchical classifications until a final child node is encountered.

19. The computer system of claim 15, wherein the hierarchical set of skills comprises a chain of two or more skills performed based on the classification.

20. The computer system of claim 15, wherein the instructions further cause the processors to:
retrieve, from a database, a plurality of categories that classify conversations based on content of the conversations;
determine whether the prompt aligns with one of the plurality of categories;
responsive to determining that the prompt does not align with one of the plurality of categories, retrieve, from the database, a set of previously proposed categories;
determine whether the prompt aligns with one of the set of previously proposed categories;
responsive to determining that the prompt does not align with one of the set of previously proposed categories, provide the prompt to the LLM to generate a new category for classifying the prompt;
receive output from the LLM, the output comprising at least one recommended category; and
tag the prompt with the at least one recommended category from the output.
